(19) United States
(12) Patent Application Publication
(10) Pub. No.: US 2008/0177433 A1
(43) Pub. Date: Jul. 24, 2008

(54) MOTOR DRIVER CONTROLLER FOR ELECTRIC BICYCLE

(75) Inventors: Kian Teck TEO, Singapore (SG); Yubin LIU, Singapore (SG)

Correspondence Address: GREENBLUM & BERNSTEIN, P.L.C., 1950 ROLAND CLARKE PLACE, RESTON, VA, 20191, US

(73) Assignees: MATSUSHITA ELECTRIC INDUSTRIAL CO., LTD., Osaka (JP); PANASONIC SEMICONDUCTOR ASIA PTE., LTD., Singapore (SG)

(21) Appl. No.: 12/018,248

(22) Filed: Jan. 23, 2008

Related U.S. Application Data
(60) Provisional application No. 60/886,413, filed on Jan. 24, 2007.

(51) Int. Cl. B60L 15/00

(52) U.S. Cl. 701/22

(57) ABSTRACT

A motor driver controller for controlling a motor equipped in an electric bicycle includes a power supply block for supplying power to the motor, a mode select block for selecting a mode between pedal assist mode and throttle/cruise mode. The pedal assist mode is controlled by a pedal assist block which detects the bicycle pedal speed. The throttle/cruise mode is controlled by a voltage track-and-follow block which produces a signal indicating the power to be supplied to the motor from the power supply block.

### BACKGROUND OF THE INVENTION

The present invention relates to a motor driver controller for electric bicycle, and more particularly, to an electric bicycle capable of operating under any one of throttle, cruise and pedal assist modes.

Nowadays, manufacturers of electric bicycles are striving to provide bicycle riders with high level of comfort and ease in operation. They achieve this by utilizing programmable microcontroller for its robust programmability. One example is found in U.S. Pat. No. 6,684,971 B2, the block diagram and state diagram of which are shown in FIG. 1 and FIG. 2, respectively.

This controller is able to implement different modes of operation to provide bicycle rider with different riding experience. Referring to FIG. 1, through different sensors, the controller is able to detect the state of throttle, tread and speed, and switch among modes (FIG. 2). In different modes, motor provides different power levels to move the bicycles; these power level settings are pre-programmed in the processor unit, a programmable microcontroller.

However, due to the use of programmable microcontroller, this solution is costly. The present invention overcomes this drawback by using simple logic gates and counters to implement the motor driver controller. It can be integrated easily into silicon and hence provide a lower cost system solution where no programmable microcontroller is required.

### SUMMARY OF THE INVENTION

An object of this invention is to implement different electric bicycle operation modes, such as throttle control, cruise control and pedal assist control, on a single motor driver controller chip. With this dedicated and lower-cost electric bicycle chip, the current programmable microcontroller used in electric bicycle can be replaced, and system cost is brought down.

According to the present invention, said electric bicycle motor driver controller comprises: a motor driver bridge operable to deliver electric power to the motor and to produce a drive current signal; a PWM logic control operable to control the motor drive bridge based on the position information, drive current signal and PWM command signal; an edge detector operable to provide fixed width pulse at a frequency proportional to the rotational speed of the motor; an error amplifier operable to force the motor speed to track the motor speed setting signal; an analog comparator operable to generate PWM command signal based on the error amplifier output and a triangular waveform; a window comparator operable to compare the motor speed setting signal with the target motor speed signal and to produce comparison results; an S-R latch operable to determine the relation between the motor speed setting signal and the target motor speed signal according to the window comparator result; a cruise mode select block operable to activate or deactivate cruise mode operation; an up/down counter operable to increase or decrease number of counts based on the S-R latch result and a clock signal; a pedal speed counter operable to count the speed of electric bicycle pedal; a decoder operable to determine the speed range of the electric bicycle pedal; a set of switches operable to selectively turn on based on the decoder result; an analog comparator operable to produce a PWM command signal based on the voltage level passing through the only closed switch and a triangular waveform; and a pedal assist mode select block operable to selectively pass through PWM command signal generated from the analog voltage track-and-follow block or pedal assist block.

The main difference between present invention and prior art is the replacement of programmable microcontroller (the processor unit of 86 as shown in FIG. 1), inside which the controlling algorithm is programmed.

### BRIEF DESCRIPTION OF THE DRAWINGS

FIG. 1 is a block diagram showing an electric bicycle controller utilizing programmable microcontroller, according to the prior art;

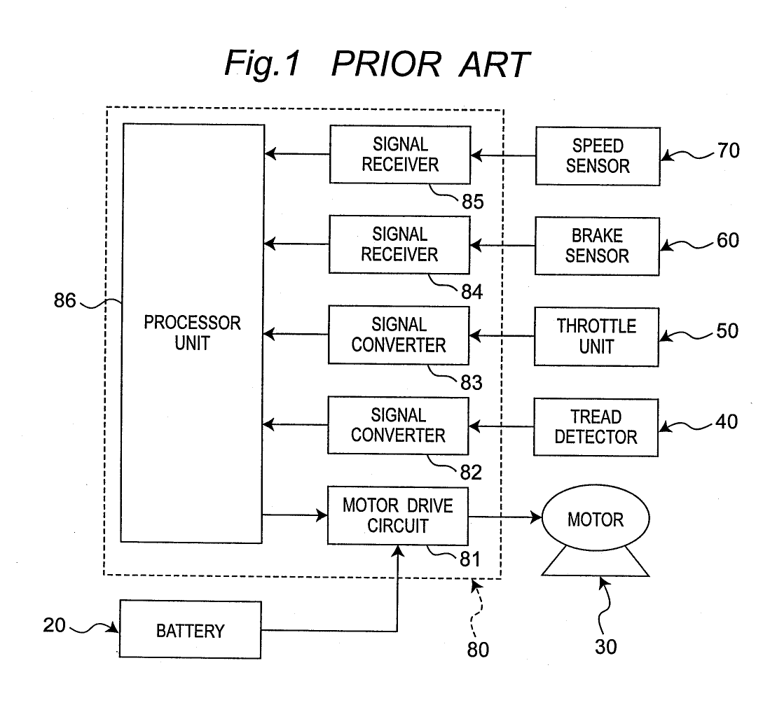

FIG. 2 is a state diagram showing different operating modes of the electric bicycle controller; and

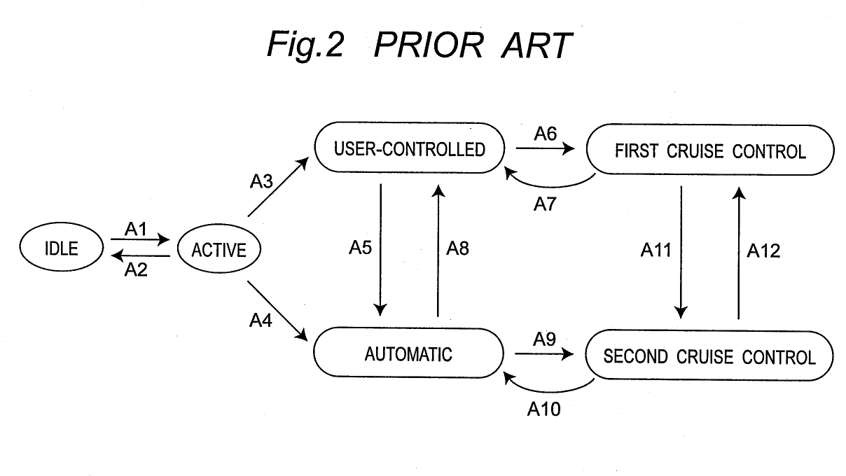

FIG. 3 is a block diagram showing an electric bicycle motor speed controller, according to the present invention.

### DETAILED DESCRIPTION OF THE PREFERRED EMBODIMENT

A motor driver controller of the present invention is designed for electric bicycle. The electric bicycle motor driver controller of the present invention is able to operate in three modes, namely, throttle mode, cruise mode and pedal assist mode. The following illustrates the throttle mode configuration.

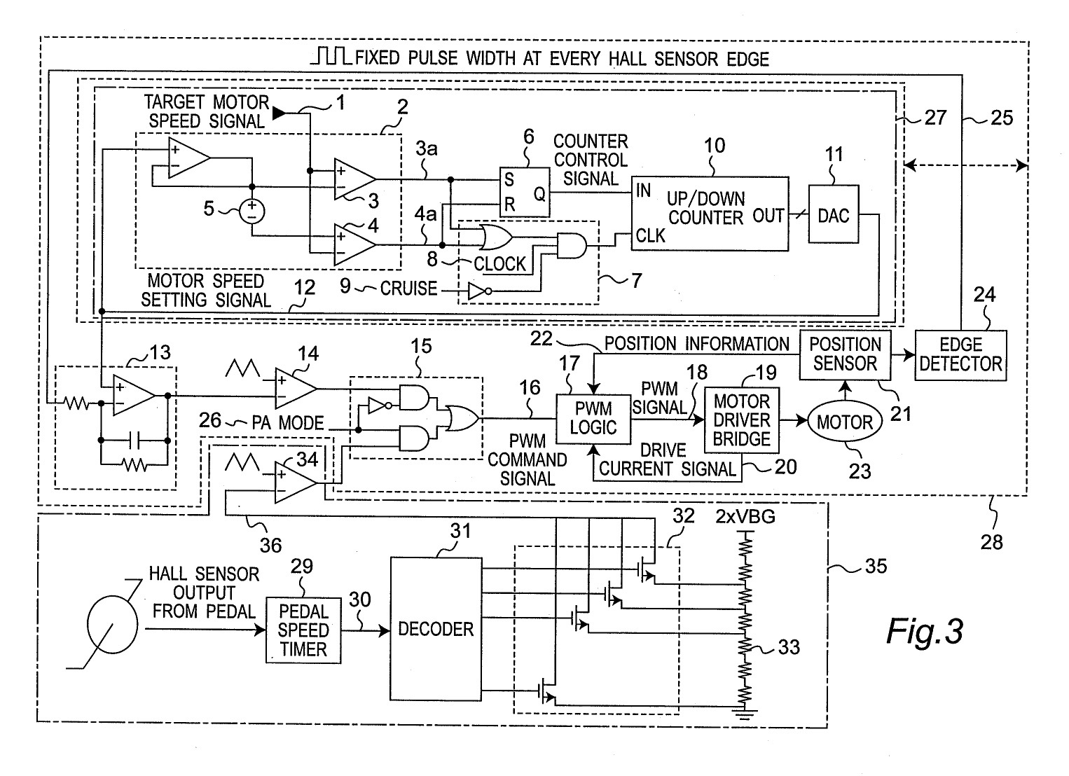

Referring to FIG. 3, the motor speed controller system for electric bicycle according to the present invention includes three main blocks: (1) an analog voltage track-and-follow block 27; (2) a motor speed control loop 28; and (3) a pedal assist block 35.

The analog voltage track-and-follow block 27 has a window comparator 2 for comparing the target motor speed signal 1 and a motor speed setting signal 12, an S-R latch 6 for producing a counter control signal based on the window comparator 2 outputs 3a and 4a, a cruise mode select block 7 for selecting either the throttle mode or the cruise mode, an up/down counter 10, under the throttle mode and in response to a clock CLK event, counts up if the counter control signal applied to “IN” thereof is HIGH, and counts down if the counter control signal is LOW, and an n-bit DAC (digital to analog converter) 11, which converts the output of counter 10 into an analog motor speed setting signal 12.

The motor speed control loop 28 in this motor speed controller for electric bicycle includes the following elements:

(1) a motor 23 connected to a wheel (not shown) of the bicycle for providing the driving force to the wheel,

(2) one or more position sensors 21 for detecting the angular position of the motor,

(3) an edge detector 24 for producing a predetermined width pulse 25 at a frequency proportional to the rotational speed of the motor,

(4) an error amplifier 13 for integrating the pulse 25 and tracking the motor speed setting signal 12,

(5) an analog comparator 14 for generating a PWM command signal 16 based on a triangular waveform and the error amplifier output,

(6) a pedal assist mode select block 15 for selectively passing through PWM command signal to drive the motor according to current selected mode of operation,

(7) a PWM (pulse width modulation) logic block 17 which receives the PWM command signal 16, drive current signal 20, as well as real-time motor position information 22, and generates a PWM signal 18,

(8) a motor driver bridge 19, that receives PWM signal 18 and supplies drive current to motor 23, and also produces the drive current signal 20. This drive current signal 20 is used to limit motor current. The motor 23 is continuously monitored by position sensor 21, which provides position information of different phases of the motor 23. This position information decides the PWM signal output to different motor phases. The above arrangement is provided for carrying out the throttle mode operation.

The electric motor speed controller for vehicles further has the following items for carrying out the pedal assist mode operation.

Referring to FIG. 3, the pedal assist block includes the following elements:

(1) A pedal speed counter 29 for counting the speed of the pedal, i.e., how fast the pedal is being stepped,

(2) a decoder 31 for decoding the current speed range and choosing the pedal assisting level,

(3) a set of switches 32 operable to turn on based on the decoder result,

(4) an analog comparator 34 operable to produce a PWM command signal based on the voltage level passing through the only closed switch and a triangular waveform.

In FIG. 3 the analog voltage track-and-follow block 27, together with a motor speed control loop 28 defines a close loop, and the pedal assist block 35, together with the motor speed loop 28 defines an open loop.

Next, the throttle mode operation is described.

The window comparator 2 receives the target motor speed signal 1, which is in the form of a throttle voltage of an electric bicycle commanded by the bicycle rider.

This target motor speed signal 1 is fed to comparator 3's non-inverting input and comparator 4's inverting input, whereas the motor speed setting signal 12 is fed to comparator 3's inverting input. A signal with a certain voltage drop of V, through an element 5, with respect to the motor speed setting signal 12 is fed to comparator 4's non-inverting input. Suppose the case when the target motor speed signal 1 is higher than the current motor speed setting signal 12, which means the motor speed setting signal 12 needs to increase to track the target motor speed signal 1, the outputs 3a and 4a of corresponding comparators 3 and 4 will be HIGH and LOW respectively. The S-R latch 6 thus performs a ‘SET’ action. Since cruise mode is not activated, the up/down counter 10 increases its count in response to a CLK event. A DAC 11 translates this digital count information into analog format, i.e., to motor speed setting signal 12.

Suppose another case when the target motor speed signal 1 is lower even than the current motor speed setting signal with V voltage drop at element 5, which means the motor speed setting signal needs to decrease to track the target motor speed signal 1, the outputs 3a and 4a of corresponding comparators 3 and 4 will be LOW and HIGH respectively. The S-R latch therefore takes a ‘RESET’ action, resulting in a lower count output from the up/down counter, and a lower level motor speed setting signal.

Suppose the last case when the target motor speed signal 1 is lower than the current motor speed setting signal 12, but higher than its replica with V voltage drop at element 5, which means the motor speed setting signal 12 has already been tracking the target motor speed signal 1, the output at comparator 3 and 4 will both be LOW. The S-R latch thus holds the previous output, and up/down counter remains at its previous output as no CLK event is triggering.

The motor speed setting signal 12 is fed to the motor speed control loop, through which the motor speed is able to track the motor speed setting signal 12. An error amplifier 13 forces the motor speed to track the motor speed setting signal by continuously adjusting the duty cycle of the PWM command signal 16 through error amplifier output. The feedback signal of this motor speed control loop 28 is fed to the negative input of the error amplifier 13. If the motor speed is lower than the motor speed setting signal 12, error amplifier 13 outputs at a higher voltage level. Together with a comparator 14 with a triangular waveform at its non-inverting input, and PWM logic 17, this higher output at error amplifier 13 results in a PWM signal with a higher duty cycle 18, which is able to drive the motor at a higher speed. This higher motor speed is detected by the edge detector 24, which accordingly outputs pulses, having a predetermined pulse width, at a frequency proportional to the rotational speed of the motor. This pulse 25 is fed to the negative input of the error amplifier 13, and closes the motor speed control loop.

On the other hand, if the motor speed signal is higher than the motor speed setting signal, error amplifier 13 outputs at a voltage lower level, which eventually regulates the motor to run at a lower speed.

In the following, cruise mode operation is described.

Cruise mode shall be activated when the electric bicycle is moving at the speed the bicycle rider is content with. The bicycle is cruising at this speed thereafter.

The cruise mode is triggered through the cruise mode select block 7. Upon activation, no CLK event will be received by the up/down counter 10. Thus, the output at up/down counter 10 remains the one just before the activation of cruise mode. Therefore, the track-and-follow block 27 latches the motor speed setting signal 12. The resulting motor speed setting signal 12 is fed to the motor speed control loop 28. The controlling mechanism in the motor speed control loop is the same as the one described above.

Next, the pedal assist mode operation is described.

Pedals of electric bicycle are equipped with Hall sensors. Suppose the pedal is continuously monitored by Hall sensors, it is possible to track the pedal's position information, and hence its speed information. These Hall sensors subsequently output a signal containing the speed information. Because of the rotational nature of pedal, the output signal from Hall sensor is a series of pulses. The output signal from the Hall sensors is applied to pedal speed counter 29. Pedal speed counter 29 counts time between two consecutive pulses from the Hall sensor, such as between two consecutive Hall sensor signal rising edges. Pedal speed counter 29 may be so arranged to count the number of pulses per a unit time. Thus, the pedal speed counter 29 detects the rotational speed of pedal. The pedal speed counter output 30 is such that, per a unit time, the faster the pedal is stepped, the greater the count is. Thus, per a unit time, the counted result of a high value corresponds to a fast pedal speed, and a low value corresponds to a slow pedal speed.

According to the pedal speed counter 29, decoder 31 decides which assisting level to provide. If the pedal is being stepped fast, higher assisting power is provided. Conversely, the slower the pedal is being stepped, lower assisting power is provided. Based on the pedal speed counter output 30, decoder 31 turns on one of switches among the set of switches 32. Hence, the corresponding voltage level connected to the switch will now be connected to the inverting input of analog comparator 34. The output of the analog comparator 34 will be the PWM signal, where through a pedal assist select block 15, only PWM signal generated from the pedal assist block 35 is fed to drive the motor.

The set of transistors 33 used to generate the voltage for the inverting input of the analog comparator 34 is just an example of the different possible ways to generate the reference voltage 36.

The switching among these three modes, throttle mode, cruise mode and pedal assist mode is accomplished via two blocks, cruise mode select block 7 and pedal assist mode select block 15. Upon start-up, the electric bicycle is in throttle mode. By asserting the cruise signal 9, cruise mode operation is activated; whereas, by asserting the pedal assist signal 26, pedal assist mode operation is activated. With the two selection blocks 7 and 15, only one of the three types of operation is allowed at a time.

According to the present invention, the electric bicycle capable of being operated under three different modes of throttle mode, cruise mode and pedal assist mode can be controlled without using a processor, but using electric selection blocks 7 and 15. Thus, the electric bicycle according to the present invention, can be manufactured at relatively low cost.

The above-described disclosure of the invention in terms of the presently preferred embodiments is not to be interpreted as intended for limiting. Various alterations and modifications will no doubt become apparent to those skilled in the art to which the invention pertains, after having read the disclosure. As a corollary to that, such alterations and modifications apparently fall within the true spirit and scope of the invention. Furthermore, it is to be understood that the appended claims be intended as covering the alterations and modifications.

What is claimed is:

1. A motor driver controller for controlling a motor equipped in an electric bicycle comprising:
a motor driver bridge operable to deliver electric power to the motor and to produce a drive current signal;
a PWM logic control operable to control the motor drive bridge;
a pedal assist mode select block operable to selectively pass PWM command signal generated from a voltage track-and-follow block or a pedal assist block;
an edge detector operable to provide fixed width pulse at a frequency proportional to the rotational speed of the motor;
said voltage track-and-follow block comprising:
a window comparator operable to compare a target motor speed signal with a motor speed setting signal;
an S-R latch operable to determine if motor speed setting signal is able to track the target motor speed signal and output a counter control signal;
a cruise mode select block operable to activate or deactivate cruise mode operation;
an up/down counter operable to increase or decrease number of counts based on the S-R latch result and a clock signal, and to produce the motor speed setting signal;
an error amplifier operable to force the motor speed to track the motor speed setting signal; and
a first comparator operable to produce a PWM command signal based on the error amplifier output and a triangular waveform.

2. A motor driver controller for electric bicycle, according to claim 1, wherein said pedal assist block comprising:
a pedal speed counter operable to count the speed of electric bicycle pedal;
a decoder operable to determine the speed range of the electric bicycle pedal;
a set of switches operable to turn on based on the decoding result; and
a second comparator operable to produce a PWM command signal based on the voltage level passing through the only closed switch and a triangular waveform.

3. A motor driver controller according to claim 2, wherein the motor is able to operate in a throttle mode, a cruise mode or a pedal assist mode.

4. A motor driver controller for controlling a motor equipped in an electric bicycle comprising:
a motor driver bridge operable to deliver electric power to the motor and to produce a drive current signal;
a PWM logic control operable to control the motor drive bridge;
a pedal assist mode select block operable to selectively pass PWM command signal generated from a voltage track-and-follow block or a pedal assist block;
wherein said pedal assist block comprising:
a pedal speed counter operable to count the speed of electric bicycle pedal;
a decoder operable to determine the speed range of the electric bicycle pedal;
a set of switches operable to turn on based on the decoding result; and
a second comparator operable to produce a PWM command signal based on the voltage level passing through the only closed switch and a triangular waveform.

5. A method for controlling the motor driver controller according to claim 1, the method comprising:
inputting a target motor speed signal;
comparing the target motor speed signal with a motor speed setting signal by said window comparator, and producing comparator results of (HIGH, LOW), (LOW, HIGH) and (LOW, LOW) which represent the motor speed setting signal is lower than, higher than, and substantially the same as the target motor speed signal, respectively;
updating the up/down counter output count according to the comparator result, and producing a motor speed setting signal proportional to the counter output;
forcing the motor speed to track the motor speed setting signal by said error amplifier;
producing a PWM command signal by said first comparator upon a comparison between the error amplifier output and a triangular waveform;
driving the motor by said motor driver bridge, directed by the PWM signal from the PWM logic block, wherein the PWM logic block produces PWM signal based on the PWM command signal, drive current signal;
detecting position sensor signal edges and producing fixed width pulse signal proportional to motor speed by said edge detector;
feeding back the pulse signal to the error amplifier, and regulating the motor speed to track the motor speed setting signal.

6. A method according to claim 5 further comprising:
keeping the electric bicycle in motion, and updating the up/down counter to track the target motor speed signal; and
activating the cruise mode by asserting a cruise mode select signal, and stop clock signal going into the up/down counter;

7. A method for controlling the motor driver controller according to claim 4, the method comprising:
activating the pedal assist mode by the PWM command signal originated from the pedal assist block;
sensing the rotational speed of the pedal, and producing the speed information by the speed counter;
decoding the speed information, and producing a speed range signal by the decoder;
generating a voltage signal relative to the speed range signal by said set of switches;
producing a PWM command signal based on said voltage signal;
driving the motor by said motor driver bridge, directed by the PWM signal from the PWM logic block, wherein the PWM logic block produces PWM signal based on the PWM command signal, drive current signal;
